(19) United States
(12) Patent Application Publication
(10) Pub. No.: US 2015/0088461 A1
(43) Pub. Date: Mar. 26, 2015

(54) FAULT DETECTING SYSTEM AND FAULT DETECTING METHOD

(71) Applicant: Azbil Corporation, Tokyo (JP)

(72) Inventor: Masato TANAKA, Tokyo (JP)

(73) Assignee: Azbil Corporation, Tokyo (JP)

(21) Appl. No.: 14/493,740

(22) Filed: Sep. 23, 2014

(30) Foreign Application Priority Data
Sep. 24, 2013 (JP) 2013-196512

(51) Int. Cl. G05B 23/02

(52) U.S. Cl. CPC G05B 23/0221; G05B 23/027
USPC 702/183

(57) ABSTRACT

A problem detecting system is provided with: a setting value operating portion that changes a setting value SP in accordance with an operation by an operator; a manipulated variable calculating portion that calculates and outputs a manipulated variable MV based on a setting value SP and a process variable PB; a frequency information processing portion that tabulates and holds operation frequency information for indicating a frequency of changes of the setting value SP by the setting value operating portion; a resetting portion that resets to zero the operation frequency information that is held in the frequency information processing portion when a reset signal has been received from the outside; and an alarm outputting portion that outputs an alarm when a value of the operation frequency information has exceeded a threshold value that is prescribed in advance.

### CROSS REFERENCE TO RELATED APPLICATION

This application claims priority under 35 U.S.C. §119 to Japanese Patent Application No. 2013-196512, filed on Sep. 24, 2013, the entire content of which being hereby incorporated herein by reference.

### FIELD OF TECHNOLOGY

The present disclosure relates to a fault detecting system and a fault detecting method able to detect, and provide advanced notification of, faults wherein an operator is unable to operate a controller, such as a temperature controller, properly.

### BACKGROUND

In semiconductor manufacturing equipment, equipment engineering systems (EES) have reached the point of moving into the practical application stage. An EES is a system that is able to improve equipment reliability and productivity through using data to check whether or not semiconductor manufacturing equipment is functioning properly. The main purposes of an EES are to perform fault detection (FD) and fault prediction (FP) on the equipment itself. See, for example, Handbook for Checking the Performance of Equipment Functions on the Equipment Level (Sochi reberu de no sochi kino no seino kakunin ni kansuru kaisetsu-sho), Japan Electronics and Information Technology Industries Association, Mar. 23, 2005.

In FD/FP, a hierarchical approach is taken on the equipment control level, the module level, the subsystem-level, and the I/O device level. FD/FP on the equipment control level is FD/FP that performs monitoring/detection of whether or not the equipment functions are operating within the tolerance range of the equipment specification, based on process conditions that have been designated by a host or an operator. FD/FP on the module level is FD/FP that performs monitoring/detection of whether or not the processing is being performed according to the specification values by a module that is structured from devices or subsystems. FD/FP on the subsystem level is FD/FP that performs monitoring/detection as to whether or not complex systems, constituting a plurality of devices, such as those that perform feedback control, are operating stably based on a variety of parameter settings. FD/FP on the I/O device level is FD/FP that performs monitoring/detection on whether or not the sensors and actuators that structure a device are operating stably according to the design values. In this way, on the I/O device level, the subjects are sensors and actuators.

When it comes to FD/FP for actuators, it can be said that sequence control operations that are based on (0, 1) bit stream data (actuator data) in particular are at the stage of practical application.

On the other hand, when it comes to FD/FP for sensors, the data of interest it are process variables, such as temperatures, pressures, flow rates, and the like. For these data, it would be irrational to attempt to store all data on the millisecond level. Given this, there have been proposals for, for example, EES-compatible substrate processing equipment wherein value representation of sensor data is performed by the process unit, for the processes handled by the equipment, or by fixed time units, where the representative values are checked. See, for example, Japanese Unexamined Patent Application Publication No. 2010-219460. The representative values are maximum values, minimum values, average values, and the like. Achieving FD/FP through representative values, when compared to monitoring all data, enables a major reduction in the communication overhead, the required memory capacity, and the like, thus contributing to efficiency.

Known cases of FD/FP wherein representative values are used include FP for heater element burnout due to wearing out over time and FD for heater element burnout due to over-current. In a case of a heater wearing out over time, the average value for the resistance value (a non-process variable) of the heater gradually rises over time, so checking the average value of the resistance value for the heater as the representative value, makes it possible to predict burnout of the heater due to wearing out over time. Moreover, in the case of burnout of a heater element due to over-current, the maximum value of the resistance value for the heater rises suddenly, and thus checks that use the maximum value of the heater resistance value as the representative value are able to detect burnout of a heater due to over-current.

FD/FP can be implemented for a non-process variable, as described above. However, when using a measure of central tendency for the process variable, this handles only the physical state, and does not extend to handling the state of the operator, and thus as information this is not necessarily adequate. Because a decentralized arrangement within EES equipment is an effective method of implementation in order to increase the overall efficiency of EES, there are calls for further strengthening the FD/FP functions on the level of device control in accordance with operations by an operator.

The present invention was created in order to solve the problems set forth above, and is to provide a fault detecting system and fault detecting method, for example, able to strengthen the FD/FP function an operator status on the device control level. In other words, the present disclosure is to provide easy FD/FP-related functions that can be built-in, or added on, on the device control level.

### SUMMARY

A fault detecting system according to the present invention comprises: manipulated variable calculating portion that calculates and outputs a manipulated variable MV based on a setting value SP and a process variable PV; a setting value operating portion that changes a setting of the setting value SP in accordance with an operation by an operator; a frequency information processing portion that tabulates and holds operation frequency information for indicating a frequency of change of the setting value SP by the setting value operating portion; and a resetting portion that resets to zero the operation frequency information that is held in the frequency information processing portion when a reset signal is received from the outside.

In an example configuration of a fault detecting system according to the present invention, the operation frequency information is repeat change frequency information indicating a frequency of changes of the setting value SP, repeat change frequency information indicating a frequency with which the setting value SP is changed again, through the setting value operating portion when the elapsed time after the setting value SP has been changed is no more than a prescribed time, and/or opposite-direction change frequency information indicating a frequency of changes of the setting value SP being in the direction opposite from the immediately preceding change in the setting value SP for a change in the setting value SP wherein the setting value SP is changed, by the setting value operating portion, when the elapsed time after a change in the setting value SP is no more than a prescribed time.

In an example configuration of a fault detecting system according to the present invention, the operation frequency information is repeat change frequency information indicating a frequency of changes of the setting value SP, repeat change frequency information indicating a frequency with which the setting value SP is changed again, through the setting value operating portion, prior to the process variable PV, after the change, arriving at the setting value SP after the setting value SP has been changed, and/or opposite-direction change frequency information indicating a frequency of changes of the setting value SP being in the direction opposite from the immediately preceding change in the setting value SP for a change in the setting value SP wherein the setting value SP is changed, by the setting value operating portion, prior to the process variable PV, after the change, arriving at the setting value SP after the setting value SP has been changed.

An example configuration of a fault detecting system according to the present invention further comprises: an alarm outputting portion that outputs an alarm when a value of the operation frequency information exceeds a threshold value prescribed in advance.

A fault detecting system according to the present invention comprises: a manipulated variable calculating portion that calculates and outputs a manipulated variable MV based on a setting value SP and a process variable PV; a setting value operating portion that changes a setting of the setting value SP in accordance with an operation by an operator; a summation information processing portion that tabulates and holds operation summation information for indicating a sum total of the magnitudes of changes of the setting value SP by the setting value operating portion; and a resetting portion that resets to zero the operation summation information that is held in the summation information processing portion when a reset signal is received from the outside.

In an example configuration of a fault detecting system according to the present invention, the operation summation information is repeat change summation information indicating a summation of the magnitudes of changes of the setting value SP, repeat change summation information indicating a summation of the magnitudes with which the setting value SP is changed again, through the setting value operating portion when the elapsed time after the setting value SP has been changed is no more than a prescribed time, and/or opposite-direction change summation information indicating a summation of the magnitudes of changes of the setting value SP being in the direction opposite from the immediately preceding change in the setting value SP for a change in the setting value SP wherein the setting value SP is changed, by the setting value operating portion, when the elapsed time after a change in the setting value SP is no more than a prescribed time.

In an example configuration of a fault detecting system according to the present invention, the operation summation information is repeat change summation information indicating a summation of the magnitudes of changes of the setting value SP, repeat change summation information indicating a summation of the magnitudes with which the setting value SP is changed again, through the setting value operating portion, prior to the process variable PV, after the change, arriving at the setting value SP after the setting value SP has been changed, and/or opposite-direction change summation information indicating a summation of the magnitudes of changes of the setting value SP being in the direction opposite from the immediately preceding change in the setting value SP for a change in the setting value SP wherein the setting value SP is changed, by the setting value operating portion, prior to the process variable PV, after the change, arriving at the setting value SP after the setting value SP has been changed.

An example configuration of a fault detecting system according to the present invention further comprises: an alarm outputting portion that outputs an alarm when a value of the operation summation information exceeds a threshold value prescribed in advance.

An example configuration of a fault detecting system according to the present invention further comprises: a frequency information acquiring portion that acquires, at intervals prescribed in advance, operation frequency information held in the frequency information processing portion; a reset value transmitting portion that transmits a reset signal to the resetting portion after the operation frequency information has been acquired; a frequency information history storing portion that stores operation frequency information acquired by the frequency information acquiring portion; and an evaluating portion that outputs an alarm when an amount of increase in a value of a most recent operation frequency information relative to a value of the operation frequency information hat an arbitrary point in the past, stored in the frequency information history storing portion, exceeds a threshold value prescribed in advance.

An example configuration of a fault detecting system according to the present invention further comprises: a summation information acquiring portion that acquires, at intervals prescribed in advance, operation summation information held in the summation information processing portion; a reset value transmitting portion that transmits a reset signal to the resetting portion after the operation summation information has been acquired; a summation information history storing portion that stores operation summation information acquired by the summation information acquiring portion; and an alarm outputting portion that outputs an alarm when an amount of increase in a value of a most recent operation summation information relative to a value of the operation summation information hat an arbitrary point in the past, stored in the summation information history storing portion, exceeds a threshold value prescribed in advance.

An example configuration of a fault detecting method according to the present invention further comprises: a manipulated variable calculating step for calculating and outputting a manipulated variable MV based on a setting value SP and a process variable PV; a frequency information processing step for tabulating and holding, by a frequency information processing portion, operation frequency information for indicating a frequency of change of the setting value SP by an operation by an operator; and a resetting step for resetting to zero the operation frequency information that is held in the frequency information processing portion when a reset signal is received from the outside.

An example configuration of a fault detecting system according to the present invention further comprises: an alarm outputting step for outputting an alarm when a value of the operation frequency information exceeds a threshold value prescribed in advance.

An example configuration of a fault detecting system according to the present invention further comprises: a manipulated variable calculating step for calculating and outputting a manipulated variable MV based on a setting value SP and a process variable PV; a summation information processing step for tabulating and holding, by a summation information processing portion, operation summation information for indicating a summation of change of the setting value SP by an operation by an operator; and a resetting step for resetting to zero the operation summation information that is held in the summation information processing portion when a reset signal is received from the outside.

An example configuration of a fault detecting system according to the present invention further comprises: an alarm outputting step for outputting an alarm when a value of the operation summation information exceeds a threshold value prescribed in advance.

An example configuration of a fault detecting method according to the present invention further comprises: a frequency information acquiring step for acquiring, at intervals prescribed in advance, operation frequency information held in the frequency information processing portion; a reset value transmitting step for transmitting a reset signal after the operation frequency information has been acquired; a frequency information history storing step for storing, into the frequency information history storing portion, operation frequency information acquired by the frequency information acquiring step; and an evaluating step for outputting an alarm when an amount of increase in a value of a most recent operation frequency information relative to a value of the operation frequency information hat an arbitrary point in the past, stored in the frequency information history storing portion, exceeds a threshold value prescribed in advance.

An example configuration of a fault detecting system according to the present invention further comprises: a summation information acquiring step for acquiring, at intervals prescribed in advance, operation summation information held in the summation information processing portion; a reset value transmitting step for transmitting a reset signal after the operation frequency information has been acquired; a summation information history storing step for storing, into the summation information history storing portion, operation summation information acquired by the summation information acquiring step; and an evaluating step for outputting an alarm when an amount of increase in a value of a most recent operation summation information relative to a value of the operation summation information hat an arbitrary point in the past, stored in the summation information history storing portion, exceeds a threshold value prescribed in advance.

In the present invention, the provision of the frequency information processing portion makes it possible to strengthen the FD/FP functions in regards to the operator status on the device control level, making it possible to detect, and provide advance notification, of faults wherein an operator is unable to operate a controller, such as a temperature controller, properly.

Moreover, the frequency with which yet another change is made to the setting value of the SP prior to the process variable PV, after a change in the setting value SP, arriving at the changed setting value SP is tabulated as repeat change frequency information, and the frequency with which the change in the setting value SP is a change in the opposite-direction from the immediately preceding change in setting value SP is tabulated as opposite-direction change frequency information, to enable detection of improper operation that is unique to a feedback control system.

Moreover, in the present invention, the provision of the summation information processing portion enables strengthening of the FD/FP functions in regards to the operator status on the device control level, enabling detection and notification in advance of faults wherein the operator is unable to operate a controller, such as the a temperature controller, or the like, properly.

Moreover, if there is yet another change made to the setting value of the SP prior to the process variable PV, after a change in the setting value SP, arriving at the changed setting value SP, the cumulative total of the magnitudes of the changes is tabulated as repeat change summation information, and if the change in the setting value SP is a change in the opposite-direction from the immediately preceding change in setting value SP them the cumulative total of the magnitude of the changes tabulated as opposite-direction change summation information, to enable detection of improper operation that is unique to a feedback control system.

Moreover, in the present invention, the provision of the frequency information acquiring portion, the frequency information history storing portion, and the evaluating portion enables the achievement of even higher levels of operator status detection.

Moreover, in the present invention, the provision of the summation information acquiring portion, the summation information history storing portion, and the evaluating portion enables the achievement of even higher levels of operator status detection.

### BRIEF DESCRIPTIONS OF THE DRAWINGS

FIG. 1 is a block diagram illustrating a structure for a fault detecting system according to Example according to the present disclosure.

FIG. 2 is a flowchart illustrating the operation of the fault detecting system according to the Example according to the present disclosure.

FIG. 3 is a diagram illustrating an example of operation of the fault detecting system according to the Example according to the present disclosure.

FIG. 4 is a block diagram illustrating a structure for a fault detecting system according to Another Example according to the present disclosure.

FIG. 5 is a flowchart illustrating the operation of the fault detecting system according to the Another Example according to the present disclosure.

FIG. 6 is a diagram illustrating an example of operation of the fault detecting system according to the Another Example according to the present disclosure.

FIG. 7 is a block diagram illustrating a structure for a fault detecting system according to Yet Another Example according to the present disclosure.

FIG. 8 is a flowchart illustrating the operation of the fault detecting system according to the Yet Another Example according to the present disclosure.

FIG. 9 is a diagram illustrating an example of operation of the fault detecting system according to the Yet Another Example according to the present disclosure.

FIG. 10 is a block diagram illustrating a structure for a fault detecting system according to Further Example according to the present disclosure.

FIG. 11 is a flowchart illustrating the operation of the fault detecting system according to the Further Example according to the present disclosure.

FIG. 12 is a block diagram illustrating a structure for a fault detecting system according to Another Further Example according to the present disclosure.

FIG. 13 is a block diagram illustrating a configuration for a heating device according to the Another Further Example according to the present disclosure.

FIG. 14 is a flowchart illustrating the operation of the fault detecting system according to the Another Further Example according to the present disclosure.

FIG. 15 is a diagram illustrating an example of a record of operation frequency information in the Another Further Example according to the present disclosure.

### DETAILED DESCRIPTION

### Aspect of the Invention

The present inventor noticed the following properties:

(A) A change to a setting value SP is a typical operation of a controller by an operator;

(B) Performing another change immediately after performing a first change in a setting value SP is unusual;

(C) The change in the setting value SP, immediately after making a first change, being a change in the opposite-direction of that change (a canceling operation) is an inefficient operation, and should not be thought of as being a proper operating sequence.

From (A) through (C), above, the inventors arrived at the concept of being able to detect, through recording the setting value SP change frequency, the frequency of repeat changes within a short time after a change in the setting value SP, and the frequency of opposite-direction changes within a short time of a change in the setting value SP, a state wherein the operator is unable to operate the controller properly. Because the amount of information recorded is not large, this can be included even on the level of simple controllers. This forms a portion of the FD/FP functions as an information detecting function. Additionally, a structure wherein these frequency information are processed on a higher-level PC, or the like, to issue alarms or provide information analysis results is practical. However, for a simple alarm function, this can be provided in the controller as well.

### Another Aspect of the Invention

There are also cases wherein, when there is a change in a setting value SP, a fine adjustment-level change is performed after a first change has been made, without the operation having been completed. For example, there are cases wherein, due to inconvenient controller operation, once a rough provisional change is made to a setting value SP and the control operation has been started, then, thereafter, a fine change is made to the setting value SP, for an intentional repeat change. In such a case, the magnitude of the repeat change within a short time after a change in setting value SP will be relatively small.

Consequently, storing not just the change frequencies for the setting value SP, but also repeat change summations, taking into account the magnitudes of the changes, and opposite-direction change summations enables more detailed analysis to be performed on a higher-level PC, or the like, that requires this information. Note that, in this case as well, a simple alarm function that uses these summation information can be provided in the controller.

### Yet Another Aspect of the Invention

When, after a change in the setting value SP, there is a repeat change to the setting value SP, there would be a tendency for error in handling if the evaluation as to whether or not the second change was within a “short time” after the first change were done on a case-by-case basis. If in a feedback control system, then the change in the setting value SP should be for the purpose of causing a process variable PV to track the setting value SP after the change therein, and thus it would be more practical to handle the frequencies and summations of the repeat changes and opposite-direction changes in the setting value SP made prior to the arrival of the process variable PV at the setting value SP (or in the neighborhood of the setting value SP) after the change in the setting value SP. That is, doing so enables detection of improper operation that is unique to a feedback control system.

### Example

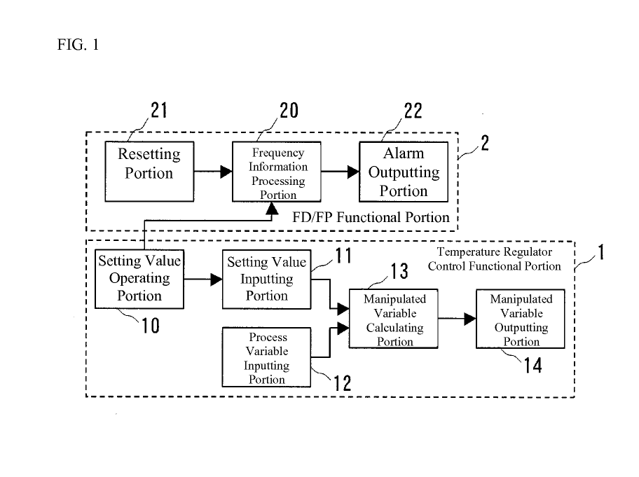

Forms for carrying out the present disclosure will be explained below in reference to the figures. FIG. 1 is a block diagram illustrating a structure for a fault detecting system according to Example according to the present disclosure. The present example is an example of corresponding to the Aspect of the Invention, set forth above. Here the explanation is an example wherein a fault detecting system is achieved in a simple controller (temperature controller). The fault detecting system of the present example is structured from a temperature controller controlling a functional portion 1, which is atypical structure that is provided in a conventional temperature controller, and an FD/FP functional portion 2, which is a distinctive structure of the present example.

The temperature controller controlling functional portion 1 comprises: a setting value operating portion 10 by which the operator changes a setting value SP through a manual operation; a setting value inputting portion 11 for inputting a setting value SP from the setting value operating portion 10; a process variable inputting portion 12 for inputting a process variable PV from a measuring instrument; a manipulated variable calculating portion 13 the calculating a manipulated variable MV based on the setting value SP and the process variable PV; and a manipulated variable outputting portion 14 for outputting the manipulated variable MV to outside of the temperature controller.

The FD/FP functional portion 2 comprises: a frequency information processing portion 20 for tabulating and holding operation frequency information that indicates a frequency of change of the setting value SP by the setting value operating portion 10; a resetting portion 21 for resetting to zero the operation frequency information that is held in the frequency information processing portion 20 when a reset signal has been received from the outside; and an alarm outputting portion 22 for outputting an alarm to outside of the temperature controller when the value of the operation frequency information exceeds a threshold value that is prescribed in advance.

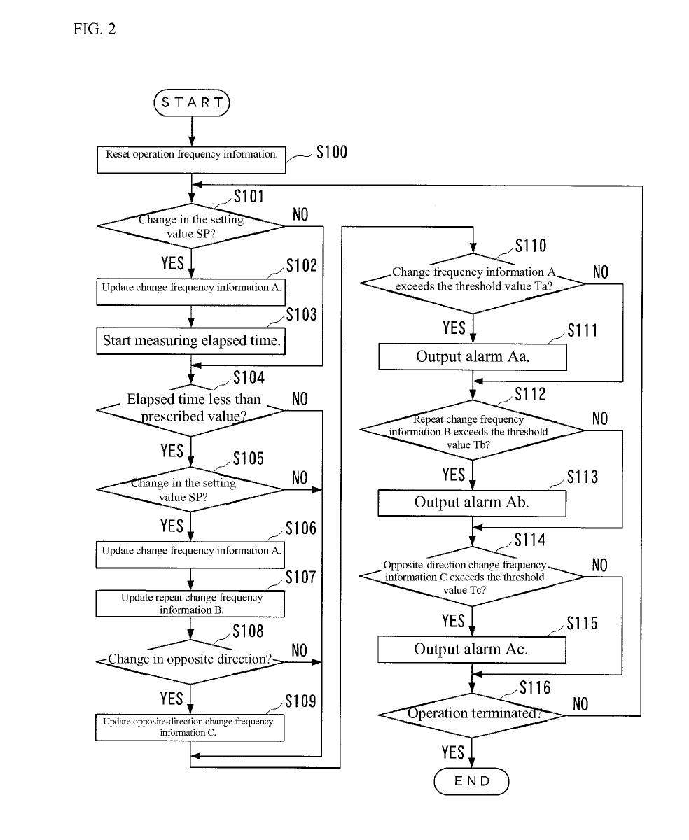

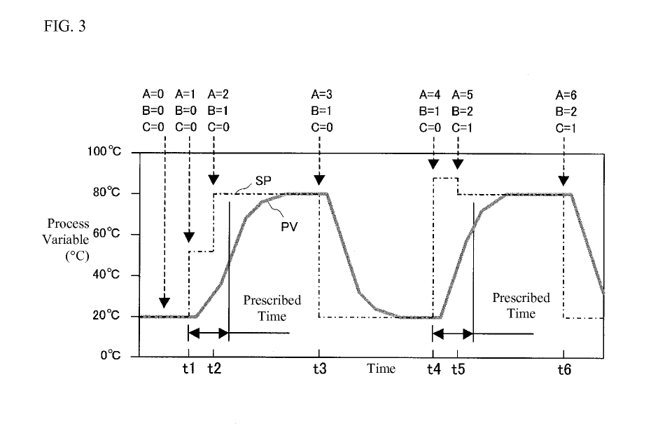

The operation of the fault detecting system according to the present example will be explained below, referencing FIG. 2. FIG. 2 is a flowchart illustrating the operation of the fault detecting system, and FIG. 3 is a diagram illustrating an example of operation of the fault detecting system. The horizontal axis in FIG. 3 is time and the vertical axis is the process variable PV (temperature). Here the explanation will be for a case wherein the setting value SP is a temperature setting value, and the process variable PV is a measured temperature value, where data is collected during a heating operation by a heat treatment furnace.

First, in the default state, a reset signal is received from the outside to cause the resetting portion 21 of the FD/FP functional portion 2 to reset, to 0, all of the operation frequency information that is held in the frequency information processing portion 20 (the change frequency information A, the repeat change frequency information B, and the opposite-direction change frequency information C) (FIG. 2, Step S100).

The change frequency information A indicates the frequency of change of the setting value SP by the setting value operating portion 10. The repeat change frequency information B indicates the frequency with which another change is made to the setting value SP, by the setting value operating portion 10, when the elapsed time after a change in the setting value SP by the setting value operating portion 10 is less than a prescribed time. The opposite-direction change frequency information C indicates the frequency with which another change is made to the setting value SP, by the setting value operating portion 10, when the elapsed time after a change in the setting value SP by the setting value operating portion 10 is less than a prescribed time and this change in the setting value SP is a change in the opposite direction from the immediately preceding change in the setting value SP.

When the controlling operation of the temperature controller is started up, the manipulated variable calculating portion 13 of the temperature controller controlling functional portion 1 follows a known control calculating algorithm to calculate a manipulated variable MV that will cause the process variable PV, inputted from the process variable inputting portion 12, to match the setting value SP that is inputted from the setting value inputting portion 11. The control calculating algorithm is, for example, a PID. The manipulated variable outputting portion 14 outputs, to the controlled instrument, the manipulated variable MV that has been calculated by the manipulated variable calculating portion 13. When the controlled instrument is, for example, a heating furnace, an electric power regulator for supplying electric power to the heater of the thermal treatment furnace will be the actual output destination for the manipulated variable MV. The temperature controller controlling functional portion 1 repetitively executes, for each control interval, the calculation and outputting of the manipulated variable in this way.

If the operator of the temperature controller wishes to change the setting value SP, then the operator changes the setting value SP by operating the setting value operating portion 10.

If, when the controlling operation by the temperature controller controlling functional portion 1 is started up, there has been a change to the setting value SP through the setting value operating portion 10 (FIG. 2, Step S101: YES), then the frequency information processing portion 20 of the FD/FP functional portion 2 updates the value for the change frequency information A depending on the change in the setting value SP as per the following equation (FIG. 2, Step S102):

A<--A+1 (1)

In the example in FIG. 3, at time t1, the setting value SP is changed from 20° C. to 52° C., so the change frequency information A is incremented by 1, updating from A=0 to A=1. Moreover, at time t3, the setting value SP is changed from 80° C. to 20° C., so the change frequency information A is updated from A=2 to A=3. Moreover, at time t4, the setting value SP is changed from 20° C. to 88° C., so the change frequency information A is updated from A=3 to A=4. Additionally, at time t6, the setting value SP is changed from 80° C. to 20° C., so the change frequency information A is updated from A=5 to A=6.

The frequency information processing portion 20 resets to 0 the elapsed time after the setting value SP was changed, and begins measuring the elapsed time (FIG. 2, Step S103), and if, when the elapsed time is less than the time that is prescribed in advance (FIG. 2, Step S104: YES), the setting value SP is changed again through the setting value operating portion 10 (FIG. 2, Step S105: YES), updates the value of the repeat change frequency information B according to the following equation (FIG. 2, Step S107) simultaneously with the updating of the value of the change frequency information A (FIG. 2, Step S106), as shown in Equation (1), in accordance with this change of the setting value SP:

B<--B+1 (2)

In the example in FIG. 3, when, at time t2, the setting value SP is changed from 52° C. to 80° C., the time elapsed since time t1 is no greater than the prescribed time, and thus the change frequency information A is incremented by 1, updating from A=1 to A=2, and, at the same time, the repeat change frequency information B is incremented by 1, updating from B=0 to B=1.

Moreover, another change is made to the setting value SP through the setting value operating portion 10 (Step S105: YES) while the time elapsed after the setting value SP was changed is no greater than the time prescribed in advance (Step S104: YES), and if this change in the setting value SP is a change in the direction that is opposite from the immediately preceding change in the setting value SP (a canceling operation) (FIG. 2, Step S108: YES), then the frequency information processing portion 20 updates the value of the opposite-direction change frequency information C according to the following equation (FIG. 2, Step S109):

C<--C+1 (3)

In the example in FIG. 3, when, at time t5, the setting value SP is changed from 88° C. to 80° C., the time elapsed since time t4 is no greater than the prescribed time, and thus the change frequency information A is incremented by 1, updating from A=4 to A=5, and, at the same time, the repeat change frequency information B is incremented by 1, updating from B=1 to B=2, and, additionally, the change is in the opposite direction from the change in the setting value SP from time t4, and thus the opposite-direction change frequency information C is also updated from C=0 to C=1.

If the value of the change frequency information A exceeds a threshold value Ta, prescribed in advance (FIG. 2, Step S110: YES), then, in response, the alarm outputting portion 22 of the FD/FP functional portion 2 outputs an alarm Aa to outside of the temperature controller (FIG. 2: Step S111).

If the value of the repeat change frequency information B exceeds a threshold value Tb, prescribed in advance (FIG. 2, Step S112: YES), then, in response, the alarm outputting portion 22 outputs an alarm Ab to outside of the temperature controller (FIG. 2: Step S113).

Moreover, if the value of the opposite-direction change frequency information C exceeds a threshold value Tc, prescribed in advance (FIG. 2, Step S114: YES), then, in response, the alarm outputting portion 22 outputs an alarm Ac to outside of the temperature controller (FIG. 2: Step S115). Note that ideally the values of the repeat change frequency information B and the opposite-direction change frequency information C should be 0. The output format of the alarms Aa, Ab, and Ac may be, for example, an output of an alarm signal to a higher-level PC.

The processes in Step S101 through S115 as described above are repeated at regular intervals until the operation of the FD/FP functional portion 2 is terminated through, for example, an instruction from an operator (YES in Step S116 in FIG. 2). The operating period of this FD/FP functional portion 2 may or may not be the same as the control interval of the temperature controller controlling functional portion 1.

Given the above, the present example enables the FD/FP function, which handles the operation frequency information regarding the setting changes of the setting value SP as information indicating the state of the operator to be distributed to the simple device control level (a temperature controller, or the like). That is, if this is a temperature control system, this detects a fault wherein the operator is unable to operate the controller properly.

### Another Example

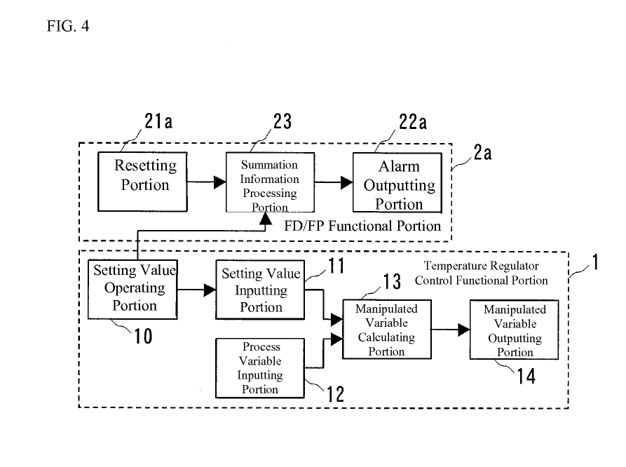

Another Example according to the present disclosure will be explained next. FIG. 4 is a block diagram illustrating a structure of a fault detecting device according to the Another Example according to the present disclosure, where structures identical to those of FIG. 1 are assigned identical codes. The present example is an example of corresponding to the Another Aspect of the Invention, set forth above. In the present example as well, the explanation is an example wherein a fault detecting system is achieved in a simple controller (temperature controller). The fault detecting system in the present example is structured from a temperature regulator control functional portion 1 and an FD/FP functional portion 2a.

The structures and operations of the temperature regulator control functional portion 1 are as explained in the Example. The FD/FP functional portion 2a comprises: a resetting portion 21a for resetting to zero the operation summation information that is held in a summation information processing portion a when a reset signal has been received from the outside; an alarm outputting portion 22a for outputting an alarm to outside of the temperature controller when the value of the operation summation information exceeds a threshold value that is prescribed in advance; and a summation information processing portion 23 for tabulating and storing operation summation information, which indicates the summation of the magnitudes of change of the setting values SP by the setting value operating portion 10.

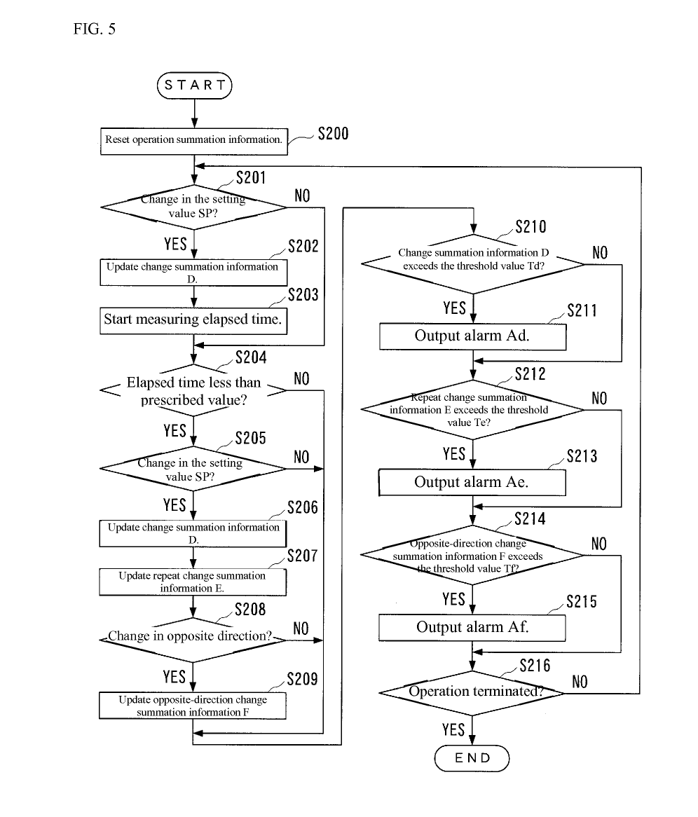

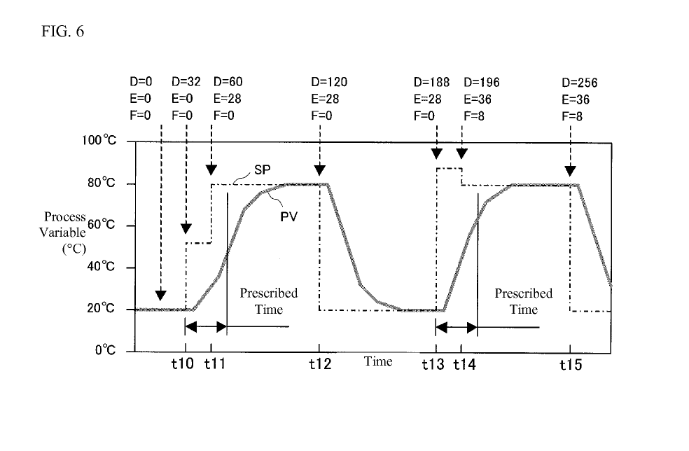

The operation of the fault detecting system according to the present example will be explained below, referencing FIG. 5 and FIG. 6. FIG. 5 is a flowchart illustrating the operation of the fault detecting system, and FIG. 6 is a diagram illustrating an example of operation of the fault detecting system. The horizontal axis in FIG. 6 is time and the vertical axis is the process variable PV (temperature).

First, in the default state, a reset signal is received from the outside to cause the resetting portion 21a of the FD/FP functional portion 2a to reset, to 0, all of the operation summation information that is held in the summation information processing portion 23 (the change summation information D, the repeat change summation information E, and the opposite-direction change summation information F) (FIG. 5, Step S200).

The change summation information D indicates the summation of the magnitudes of changes of the setting value SP by the setting value operating portion 10. The repeat change summation information E indicates the sum total of the magnitudes of the changes when another change is made to the setting value SP, by the setting value operating portion 10, when the elapsed time after a change in the setting value SP by the setting value operating portion 10 is less than a prescribed time. The opposite-direction change summation information C indicates the sum total of the magnitudes of the changes when another change is made to the setting value SP, by the setting value operating portion 10, when the elapsed time after a change in the setting value SP by the setting value operating portion 10 is less than a prescribed time and this change in the setting value SP is a change in the opposite direction from the immediately preceding change in the setting value SP.

If, when the controlling operation by the temperature controller controlling functional portion 1 is started up, there has been a change to the setting value SP through the setting value operating portion 10 (FIG. 5, Step S201: YES), then the summation information processing portion 23 of the FD/FP functional portion 2a detects the magnitude of the change ΔSP of the setting value SP for the value of the setting value SP from prior to the change, and updates the value for the change summation information D as per the following equation (FIG. 5, Step S202):

wD<--D+|ΔSP| (4)

In the example in FIG. 6, at time t10, the setting value SP is changed from 20° C. to 50° C., so the change summation information D is increased by the absolute value |ΔSP|=32 of the change magnitude ΔSP, updating from D=0 to D=32. Furthermore, at time t12, the setting value SP is changed from 80° C. to 20° C., so the change summation information D is increased by the absolute value |ΔSP|=60 of the change magnitude ΔSP, updating from D=60 to D=120. Furthermore, at time t132, the setting value SP is changed from 20° C. to 88° C., so the change summation information D is increased by the absolute value |ΔSP|=68 of the change magnitude ΔSP, updating from D=120 to D=188. Moreover, at time t15, the setting value SP is changed from 80° C. to 20° C., so the change summation information D is increased by the absolute value |ΔSP|=60 of the change magnitude ΔSP, updating from D=196 to D=256.

The summation information processing portion 23 resets to 0 the elapsed time after the setting value SP was changed, and begins measuring the elapsed time (FIG. 5, Step S203), and if, when the elapsed time is less than the prescribed time (FIG. 5, Step S204: YES), the setting value SP is changed again through the setting value operating portion 10 (FIG. 5, Step S205: YES), detects the change magnitude ΔSP of the setting value SP relative to the value for the setting value SP prior to the change and updates the value of the repeat change summation information E according to the following equation (FIG. 5, Step S207) simultaneously with the updating of the value of the change summation information A, as shown in Equation (5), in accordance with this change of the setting value SP (FIG. 5, Step S206):

E<--E+|ΔSP| (5)

In the example in FIG. 6, when, at time t11, the setting value SP is changed from 52° C. to 80° C., the time elapsed since time t10 is no greater than the prescribed time, and thus the change summation information D is incremented by the absolute value |ΔSP|=28 of the change magnitude ΔSP, updating from D=32 to D=60, and, at the same time, the repeat change summation information E is updated from E=0 to E=28.

Moreover, another change is made to the setting value SP through the setting value operating portion 10 (Step S205: YES) while the time elapsed after the setting value SP was changed is no greater than the prescribed time (Step 2104: YES), and if this change in the setting value SP is a change in the direction that is opposite from the immediately preceding change in the setting value SP (a canceling operation) (FIG. 5, Step S208: YES), then the summation information processing portion 23 updates the value of the opposite-direction change summation information F according to the following equation (22, Step S209):

F<--F+|ΔSP| (6)

In the example in FIG. 6, when, at time t14, the setting value SP is changed from 88° C. to 80° C., the time elapsed since time t13 is no greater than the prescribed time, and thus the change summation information D is incremented by the absolute value |ΔSP|=8 of the magnitude of change ΔSP, updating from D=188 to D=196, and, at the same time, the repeat change summation information E is updated from E=28 to E=36, and, additionally, the change is in the opposite direction from the change in the setting value SP from time t13, and thus the opposite-direction change summation information F is also updated from F=0 to F=8.

If the value of the change summation information D exceeds a threshold value Td, prescribed in advance (FIG. 5, Step S210: YES), then, in response, the alarm outputting portion 22a of the FD/FP functional portion 5a outputs an alarm Ad to outside of the temperature controller (FIG. 2: Step S211).

If the value of the repeat change summation information E exceeds a threshold value Te, prescribed in advance (FIG. 5, Step S212: YES), then, in response, the alarm outputting portion 22a outputs an alarm Ae to outside of the temperature controller (FIG. 5: Step S213).

Moreover, if the value of the opposite-direction change summation information F exceeds a threshold value Tf, prescribed in advance (FIG. 5, Step S214: YES), then, in response, the alarm outputting portion 22a outputs an alarm Af to outside of the temperature controller (FIG. 5: Step S215). Note that ideally the values of the repeat change summation information E and the opposite-direction change summation information F should be 0. The output format of the alarms Ad, Ae, and Af may be, for example, an output of an alarm signal to a higher-level PC.

The processes in Step S201 through S215 as described above are repeated at regular intervals until the operation of the FD/FP functional portion 2a is terminated through, for example, an instruction from an operator (YES in Step S216 in FIG. 5).

The present example enables the FD/FP function, which handles the operation summation information regarding the setting changes of the setting value SP as information indicating the state of the operator to be distributed to the simple device control level (a temperature controller, or the like). That is, if this is a temperature control system, this detects a fault wherein the operator is unable to operate the controller properly. If the present example is used in conjunction with the Example, then even more detailed analysis will be performed on the higher-level PC, or the like.

### Yet Another Example

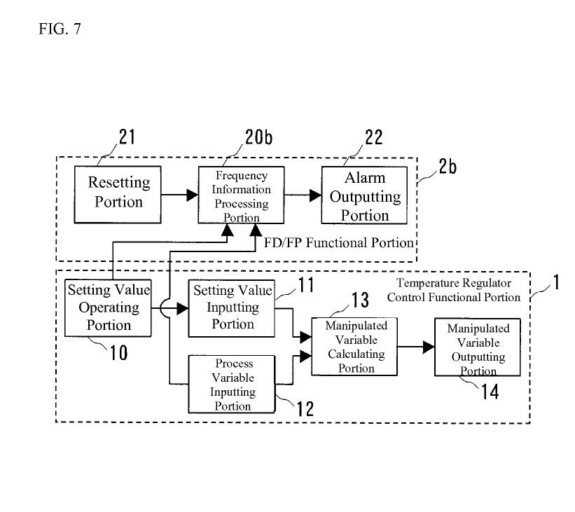

Yet Another Example according to the present disclosure will be explained next. FIG. 7 is a block diagram illustrating a structure of a fault detecting device according to the Yet Another Example according to the present disclosure, where structures identical to those of FIG. 1 are assigned identical codes. The present example is an example corresponding to the Aspect of the Invention and the Yet Another Aspect of the Invention. In the present example as well, the explanation is an example wherein a fault detecting system is achieved in a simple controller (temperature controller). The fault detecting system in the present example is structured from a temperature regulator control functional portion 1 and an FD/FP functional portion 2b.

The structures and operations of the temperature regulator control functional portion 1 are as explained in the Example. The FD/FP functional portion 2b comprises: a frequency information processing portion 20b that tabulates and holds the operation frequency information that indicates the frequency of changes of the setting value SP by the setting value operating portion 10, referencing the setting value SP and the process variable PV, a resetting portion 21, and an alarm outputting portion 22.

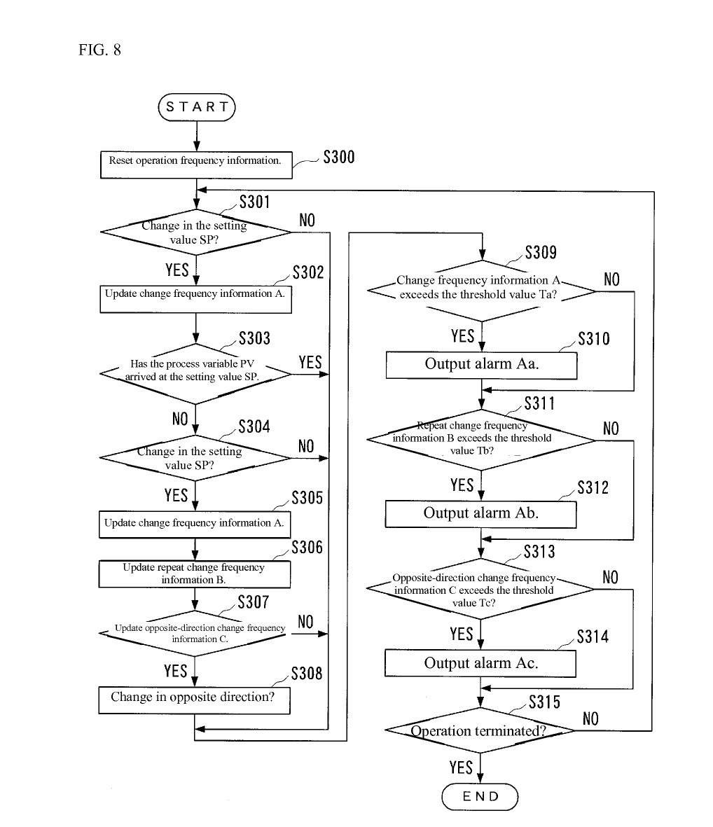

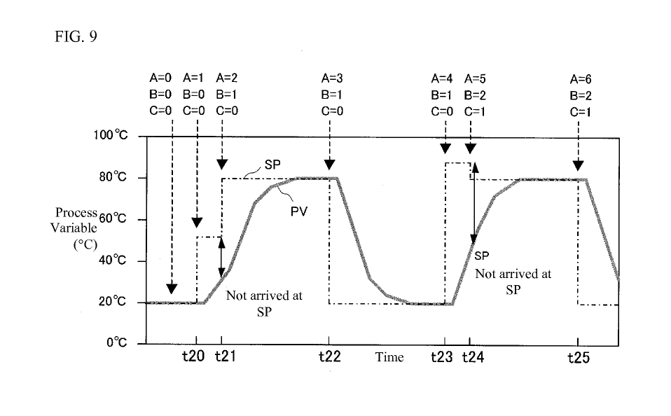

The operation of the fault detecting system according to the present example will be explained below, referencing FIG. 8 and FIG. 9. FIG. 8 is a flowchart illustrating the operation of the fault detecting system. FIG. 9 is a diagram illustrating example operation of the fault detecting system. The horizontal axis in FIG. 9 is time and the vertical axis is the process variable PV (temperature).

First, in the default state, a reset signal is received from the outside to cause the resetting portion 21 of the FD/FP functional portion 2b to reset, to 0, all of the operation frequency information that is held in the frequency information processing portion 20b (the change frequency information A, the repeat change frequency information B, and the opposite-direction change frequency information C) (FIG. 8, Step S300).

If, when the controlling operation by the temperature controller controlling functional portion 1 is started up, there has been a change to the setting value SP through the setting value operating portion 10 (FIG. 2, Step S301: YES), then the frequency information processing portion 20b of the FD/FP functional portion 2b him8 updates the value for the change frequency information A depending on the change in the setting value SP as per equation (1) (FIG. 8, Step S302):

In the example in FIG. 9, at time 20, the setting value SP is changed from 20° C. to 52° C., so the change frequency information A is incremented by 1, updating from A=0 to A=1. Moreover, at time t22, the setting value SP is changed from 80° C. to 20° C., so the change frequency information A is updated from A=2 to A=3. Moreover, at time t23, the setting value SP is changed from 20° C. to 88° C., so the change frequency information A is updated from A=3 to A=4. Additionally, at time t25, the setting value SP is changed from 80° C. to 20° C., so the change frequency information A is updated from A=5 to A=6.

The frequency information processing portion 20b references the setting value SP and the process variable PV, and if the setting value SP is changed again through the setting value operating portion 10 (FIG. 8, Step S304: YES) prior to the process variable PV arriving at the setting value SP after the change (FIG. 8, Step S303: NO), updates the value of the repeat change frequency information B according to Equation (2)(FIG. 8, Step S306) simultaneously with the updating of the value of the change frequency information A (FIG. 8, Step S305), as shown in Equation (1), in accordance with this change of the setting value SP.

In the example in FIG. 9, when, at time t21, the setting value SP is changed from 52° C. to 80° C., the process variable PV has not reached the setting value SP=52° C. of the immediately preceding change, and thus the change frequency information A is incremented by 1, updating from A=1 to A=2, and, at the same time, the repeat change frequency information B is incremented by 1, updating from B=0 to B=1.

Moreover, another change is made to the setting value SP through the setting value operating portion 10 (Step S304: YES) before the process variable PV has arrived at the setting value SP, as described above (FIG. 8, Step S303: NO), and if this most recent change in the setting value SP that is performed in Step S304 is a change in the direction that is opposite from the immediately preceding change in the setting value SP (a canceling operation) that was performed in Step S301 (FIG. 8, Step S307: YES), then the frequency information processing portion 20b updates the value of the opposite-direction change frequency information C according to the Equation (3) (FIG. 8, Step S308).

In the example in FIG. 9, when, at time t24, the setting value SP is changed from 88° C. to 80° C., the process variable PV has not reached the setting value SP=88° C. from the immediately preceding change, and thus the change frequency information A is incremented by 1, updating from A=4 to A=5, and, at the same time, the repeat change frequency information B is incremented by 1, updating from B=1 to B=2, and, additionally, the change is in the opposite direction from the change in the setting value SP from time t23, and thus the opposite-direction change frequency information C is also updated from C=0 to C=1.

The processes in Steps S309, S310, S311, S312, S313, S314 of FIG. 8 are identical to those of Steps S110, S111, S112, S113, S114, S115 in FIG. 2, so the explanations thereof will be omitted.

The processes in Step S301 through S314 as described above are repeated at regular intervals until the operation of the FD/FP functional portion 2b is terminated through, for example, an instruction from an operator (YES in Step S315 in FIG. 8). That is, the present example also enables detection of improper operation that is unique to a feedback control system.

### Further Example

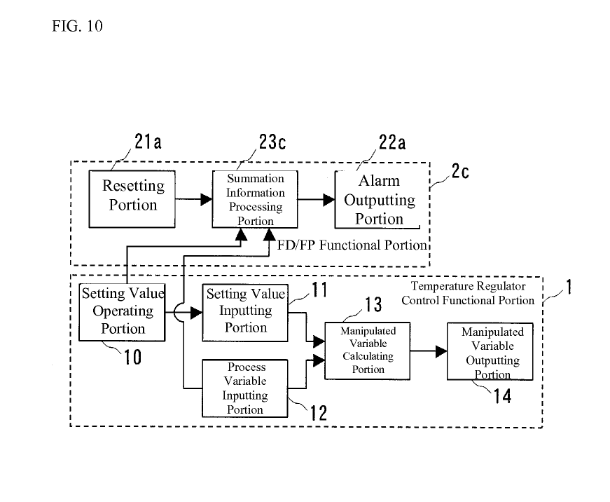

While the Yet Another Example incorporated the Yet Another Aspect of the present invention into the Example (the Aspect of the present invention), the Yet Another Aspect of the present invention can also be incorporated into the Another Example (the Another Aspect of the present invention). FIG. 10 is a block diagram illustrating a structure of a fault detecting device according to Further Example according to the present disclosure, where structures identical to those of FIG. 4 are assigned identical codes. The fault detecting system in the present example is structured from a temperature regulator control functional portion 1 and an FD/FP functional portion 2c.

The structures and operations of the temperature regulator control functional portion 1 are as explained in the Example. The FD/FP functional portion 2c comprises: a resetting portion 21a, an alarm outputting portion 22a, and a summation information processing portion 23c that tabulates and holds the operation summation information that indicates the summation of changes of the setting value SP by the setting value operating portion 10, referencing the setting value SP and the process variable PV.

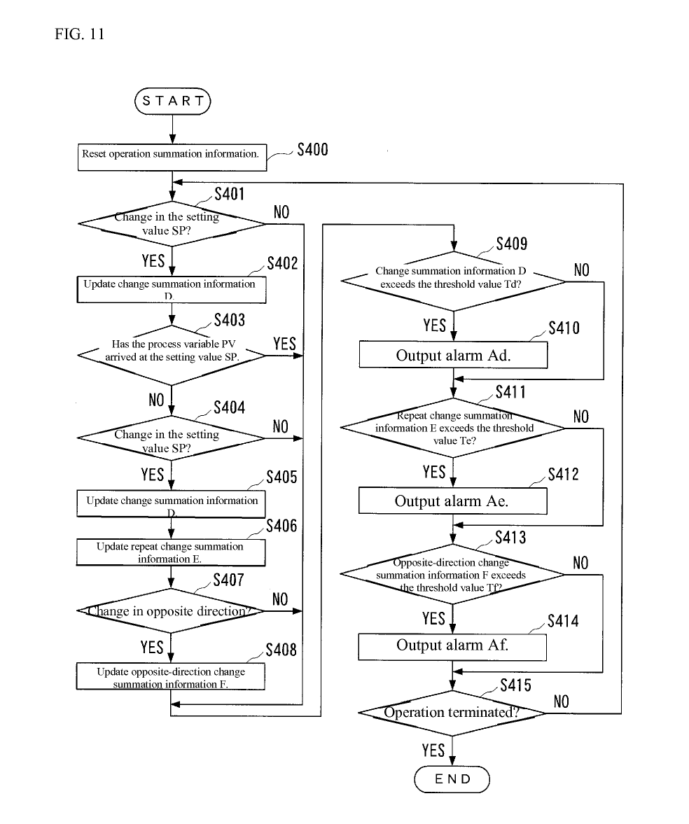

The operation of the fault detecting system according to the present example will be explained below, referencing FIG. 11. First, in the default state, a reset signal is received from the outside to cause the resetting portion 21a of the FD/FP functional portion 2c to reset, to 0, all of the operation summation information that is held in the summation information processing portion 23 (the change summation information D, the repeat change summation information E, and the opposite-direction change summation information F) (FIG. 11, Step S400).

If, when the controlling operation by the temperature controller controlling functional portion 1 is started up, there has been a change to the setting value SP through the setting value operating portion 10 (FIG. 11, Step S401: YES), then the summation information processing portion 23c of the FD/FP functional portion 2c detects the magnitude of the change ΔSP of the setting value SP for the value of the setting value SP from prior to the change, and updates the value for the change summation information D as per the Equation (4) (FIG. 11, Step S402).

The summation information processing portion 23c references the setting value SP and the process variable PV, and if the setting value SP is changed again through the setting value operating portion 10 (FIG. 11, Step S404: YES) prior to the process variable PV arriving at the setting value SP after the change (FIG. 11, Step S403: NO), detects the magnitude of the change ΔSP of the setting value SP for the value of the setting value SP from prior to the change (that is, the value of the setting value SP after the change from Step S401)) to update the value of the change summation information D according to Equation (4) (FIG. 11, Step S405), and, simultaneously, updates the repeat change summation information E as shown in Equation (5) (FIG. 11, Step S406).

Moreover, another change is made to the setting value SP through the setting value operating portion 10 (Step S404: YES) before the process variable PV has arrived at the setting value SP, as described above (FIG. 11, Step S403: NO), and if this most recent change in the setting value SP that is performed in Step S404 is a change in the direction that is opposite from the immediately preceding change in the setting value SP (a canceling operation) that was performed in Step S401 (FIG. 11, Step S407: YES), then the summation information processing portion 23c updates the value of the opposite-direction change frequency information F according to the Equation (6) (FIG. 11, Step S408).

The processes in Steps S409, S410, S411, S412, S413, S414 of FIG. 11 are identical to those of Steps S210, S211, S212, S213, S214, S215 in FIG. 5, so the explanations thereof will be omitted.

The processes in Step S401 through S414 as described above are repeated at regular intervals until the operation of the FD/FP functional portion 2c is terminated through, for example, an instruction from an operator (YES in Step S415 in FIG. 11). That is, in the same manner as with the Yet Another Example, the present example also enables detection of improper operation that is unique to a feedback control system.

### Another Further Example

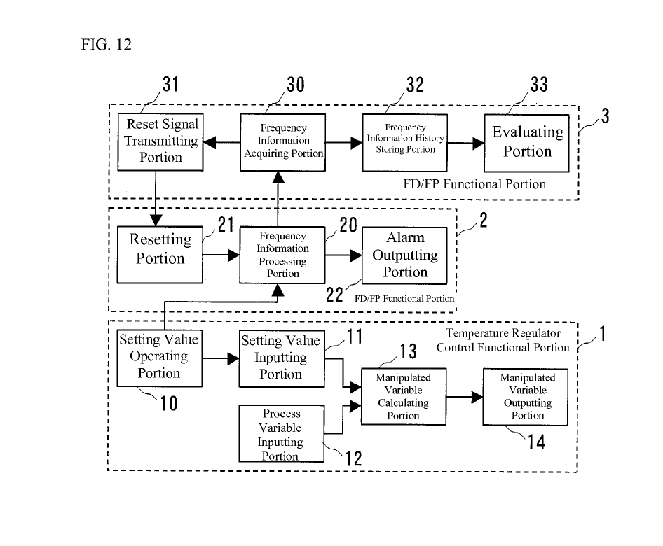

Another Further Example according to the present disclosure will be explained next. The present example will use, as an example, a case wherein the fault detecting system set forth in the Example is applied to a temperature controlling system of a heating device. FIG. 12 is a block diagram illustrating the structure of a fault detecting system according to the present example, where structures identical to those in FIG. 1 are assigned identical codes. The fault detecting system in the present example is structured from a temperature regulator control functional portion 1, an FD/FP functional portion 2, and an FD/FP functional portion 3.

The structures and operations of the temperature regulator control functional portion 1 and the FD/FP functional portion 2 are as explained in the Example. The FD/FP functional portion 3 is provided with a frequency information acquiring portion 30 for acquiring, at intervals that are set in advance, the operation frequency information (the change frequency information A, the repeat change frequency information B, and the opposite-direction change frequency information C) that is held in the frequency information processing portion 20, a reset signal transmitting portion 31 for sending a reset signal to the presetting portion 21 after acquiring the operation frequency information, a frequency information history storing portion 32 for storing the operation frequency information acquired by the frequency information acquiring portion 30, and an evaluating portion 33 for outputting an alarm, indicating a risk, when there has been a move to a state wherein the operator is unable to operate the temperature regulator properly when the amount of increase in the most recent value for the operation frequency information, relative to a value for the operation frequency information from an arbitrary point in the past, stored in the frequency information history storing portion 32, exceeds a threshold value that has been prescribed in advance.

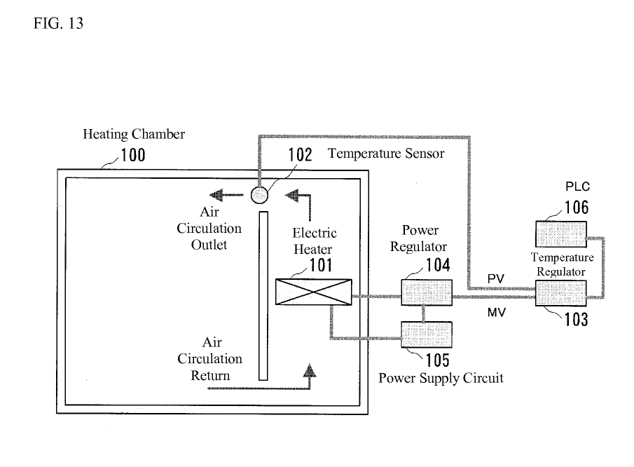

FIG. 13 is a block diagram illustrating one configuration of a heating device to which the present example can be applied. The heating device is structured from a heating chamber 100 for heating an object that is to be heated, subject to processing; an electric heater 101; a temperature sensor 102 that measures the temperature within the heating chamber 100; a temperature regulator 103 for controlling the temperature within the heating chamber 100; a power regulator 104; a power supplying circuit 105; and a PLC (Programmable Logic Controller) 106 for controlling the heating device as a whole.

The temperature regulator 103 calculates an operating variable MV so that a temperature PV that is measured by a temperature sensor 102 will go to a temperature setting value SP. The power regulator 104 determines the electric power in accordance with the operating variable MV. The power supplying circuit 105 supplies, to an electric heater 101, the power that has been determined. In this way, the temperature regulator 103 controls the temperature of the object that is heated within the heating chamber 100.

The temperature regulator control functional portion 1 and FD/FP functional portion 2 are incorporated into the temperature regulator 103, and the FD/FP functional portion 3 is incorporated into a PLC 106, which is made from a PC on a higher level than the temperature regulator 103.

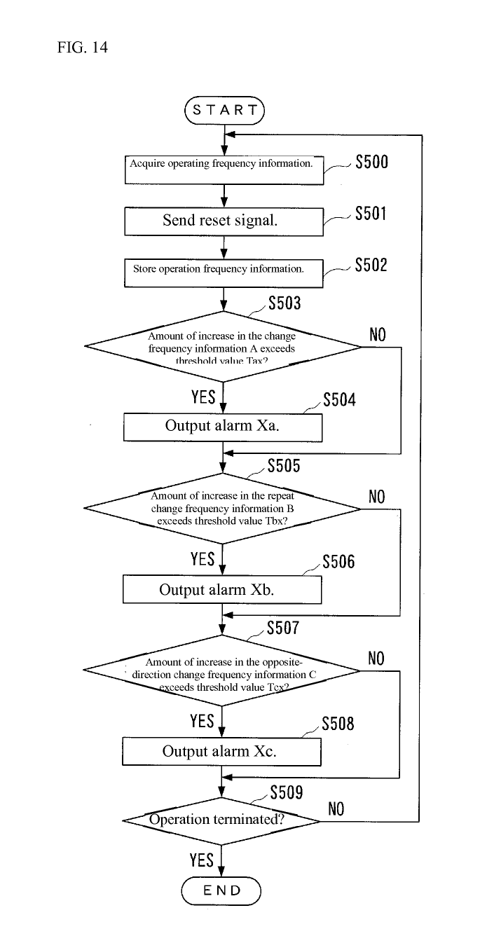

The operation of the FP/FD functional portion 3 of the fault detecting system according to the present example will be explained next, referencing FIG. 14.

The frequency information acquiring portion 30 acquires the operation frequency information (the change frequency information A, the repeat change frequency information B, and the opposite-direction change frequency information C) that is held in the frequency information processing portion 20b of the FD/FP functional portion 2 (FIG. 14, Step S500).

After acquiring the operation frequency information, the frequency information acquiring portion 30 instructs the reset signal transmitting portion 31 to send a reset signal. In response to this instruction, the reset signal transmitting portion 31 sends a reset signal to the resetting portion 21 of the FD/FP functional portion 2 (FIG. 14, Step S501). The structures and operations of the resetting portion 21 are as explained in the Example.

The frequency information history storing portion 32 stores the operation frequency information acquired by the frequency information acquiring portion 30 (FIG. 14, Step S502).

The evaluating portion 33 compares the most recent change frequency information A, acquired by the frequency information acquiring portion 30, to change frequency information A from an arbitrary point in the past, stored in the frequency information history storing portion 32, and if the amount of increase in the most recent change frequency information A, relative to the value of the change frequency information A from the past exceeds, a threshold value Tax that is prescribed in advance (FIG. 14, Step S503), outputs an alarm Xa, indicating a risk that there has been a move to a state wherein the operator is unable to operate the temperature regulator properly (FIG. 14, Step S504).

The evaluating portion 33 compares the most recent repeat change frequency information B, acquired by the frequency information acquiring portion 30, to repeat change frequency information B from an arbitrary point in the past, stored in the frequency information history storing portion 32, and if the amount of increase in the most recent repeat change frequency information B, relative to the value of the repeat change frequency information B from the past exceeds, a threshold value Tbx that is prescribed in advance (FIG. 14, Step S505), outputs an alarm Xb, indicating a risk that there has been a move to a state wherein the operator is unable to operate the temperature regulator properly (FIG. 14, Step S506).

Also, the evaluating portion 33 compares the most recent opposite-direction change frequency information C, acquired by the frequency information acquiring portion 30, to opposite-direction change frequency information C from an arbitrary point in the past, stored in the frequency information history storing portion 32, and if the amount of increase in the most recent opposite-direction change frequency information C, relative to the value of the opposite-direction change frequency information C from the past exceeds, a threshold value Tcx that is prescribed in advance (FIG. 14, Step S507), outputs an alarm Xc, indicating a risk that there has been a move to a state wherein the operator is unable to operate the temperature regulator properly (FIG. 14, Step S508). The output format of the alarms Xa, Xb, and Xc may be, for example, flashing of an LED, display of a message, sounding of an alarm tone, or the like.

The processes in Step S500 through S508 as described above are repeated at regular intervals until the operation of the FD/FP functional portion 3 is terminated through, for example, an instruction from an operator (YES in Step S509 in FIG. 14). The operating period of this FD/FP functional portion 3 is set to be longer than the operating period for the FD/FP functional portion 2 and the control interval of the temperature controller controlling functional portion 1.

### Operator Status Detecting Example

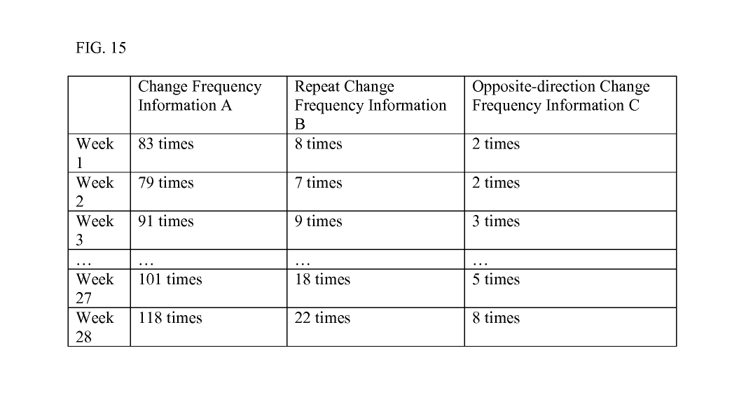

A case wherein the fault detecting system according to the present example is applied to the temperature controlling system of the thermal treatment device shown in FIG. 13 will be explained here. In the manufacturing process that uses the heating device, there may be various changes in temperature and various heating processes depending on the product being manufactured, but the heating patterns are limited, and it is assumed that within a one-week period, the standard heating patterns will be executed in roughly average frequencies. Consequently, the operating period for the FD/FP functional portion 3 is set to 1 week. The threshold values are set to Tax=50 times, Tbx=10 times, and Tcx=5 times. The operation frequency information (change frequency information A, repeat change frequency information B, and opposite-direction change frequency information C) are stored, as illustrated in FIG. 15, once per week in the frequency information history storing portion 32.

As is clear from FIG. 15, in week 27 and week 28, the values for the respective repeat change frequency information B had an increase of more than the threshold value Tbx=10 times beyond the value of the repeat change frequency information B for the second week, at least (18 times−7 times=11 times, and 22 times−7 times=15 times), and so the alarm Xb is outputted.

Moreover, in week 28, the value for the opposite-direction change frequency information C had an increase of more than the threshold value Tcx=5 times beyond the values of the opposite-direction change frequency information C for the first and second weeks, at least (8 times−2 times=6 times), and so the alarm Xc is outputted.

As described above, the present invention has an even greater ability to detect the state of the operator, when compared to that of the Example. The present example identifies the risk when switching to a state wherein the operator is unable to operate the temperature controller 103 properly, due to switching the operator, allowing the production process manager to take appropriate action.

Note that while in the present example the FD/FP functional portion 3 was applied to the Example, the FD/FP functional portion 3 may, of course, also be applied to the Another Example, the Yet Another Example and the Further Example. When the FD/FP functional portion 3 is applied to the Another Example or the Further Example, then instead of the frequency information acquiring portion 30 and the frequency information history storing portion 32, a summation information acquiring portion for acquiring, at intervals that are prescribed in advance, the operation summation information that is held in the summation information processing portions 23 and 23c, and a summation information history storing portion for storing operation summation information that is acquired from the summation information acquiring portion are provided, and when the increase in the most recent value for the operation summation information, relative to an arbitrary operation summation information from the past, stored in the summation information history storing portion, exceeds a threshold value that is prescribed in advance, the evaluating portion 33 may output an alarm.

Note that while in the prior art the decentralized distribution of the EES within devices was addressed as the issue, the Example, the Another Example, the Yet Another Example, the Further Example and the Another Further Example are not limited to EES's, but rather may be implemented in a range that applies also to the level of device controllers used in air-conditioning control in buildings, in chemical plants, and the like.

The fault detecting systems explained in the Example, the Another Example, the Yet Another Example, the Further Example and the Another Further Example can be embodied through a computer that is provided with a CPU (Central Processing Unit), a memory device, and an interface, and a program for controlling these hardware resources. The CPU executes the processes explained in the Example, the Another Example, the Yet Another Example, the Further Example and the Another Further Example, in accordance with a program that is stored in the memory device. Note that, as explained above, when the fault detecting system is decentralized into a plurality of devices, the CPU of each individual device may execute a process following a program that is stored in the storage device of that particular device.

The present disclosure can be applied to technologies able to detect, and provide advanced notification of, faults wherein an operator is unable to operate a controller, such as a temperature controller, properly.

1: A fault detecting system comprising:
a manipulated variable calculating portion that calculates and outputs a manipulated variable MV based on a setting value SP and a process variable PV;
a setting value operating portion that changes a setting of the setting value SP in accordance with an operation by an operator;
a frequency information processing portion that tabulates and holds operation frequency information for indicating a frequency of change of the setting value SP by the setting value operating portion; and
a resetting portion that resets to zero the operation frequency information that is held in the frequency information processing portion when a reset signal is received from the outside.

2. The fault detecting system as set forth in claim 1, wherein:
the operation frequency information is repeat change frequency information indicating a frequency of changes of the setting value SP, repeat change frequency information indicating a frequency with which the setting value SP is changed again, through the setting value operating portion when the elapsed time after the setting value SP has been changed is no more than a prescribed time, and/or opposite-direction change frequency information indicating a frequency of changes of the setting value SP being in the direction opposite from the immediately preceding change in the setting value SP for a change in the setting value SP wherein the setting value SP is changed, by the setting value operating portion, when the elapsed time after a change in the setting value SP is no more than a prescribed time.

3. The fault detecting system as set forth in claim 1, wherein:
the operation frequency information is repeat change frequency information indicating a frequency of changes of the setting value SP, repeat change frequency information indicating a frequency with which the setting value SP is changed again, through the setting value operating portion, prior to the process variable PV, after the change, arriving at the setting value SP after the setting value SP has been changed, and/or opposite-direction change frequency information indicating a frequency of changes of the setting value SP being in the direction opposite from the immediately preceding change in the setting value SP for a change in the setting value SP wherein the setting value SP is changed, by the setting value operating portion, prior to the process variable PV, after the change, arriving at the setting value SP after the setting value SP has been changed.

4. The fault detecting system as set forth in claim 1, further comprising:
an alarm outputting portion that outputs an alarm when a value of the operation frequency information exceeds a threshold value prescribed in advance.

5. A fault detecting system comprising:
a manipulated variable calculating portion that calculates and outputs a manipulated variable MV based on a setting value SP and a process variable PV;
a setting value operating portion that changes a setting of the setting value SP in accordance with an operation by an operator;
a summation information processing portion that tabulates and holds operation summation information for indicating a sum total of the magnitudes of changes of the setting value SP by the setting value operating portion; and
a resetting portion that resets to zero the operation summation information that is held in the summation information processing portion when a reset signal is received from the outside.

6. The fault detecting system as set forth in claim 5, wherein:
the operation summation information is repeat change summation information indicating a summation of the magnitudes of changes of the setting value SP, repeat change summation information indicating a summation of the magnitudes with which the setting value SP is changed again, through the setting value operating portion when the elapsed time after the setting value SP has been changed is no more than a prescribed time, and/or opposite-direction change summation information indicating a summation of the magnitudes of changes of the setting value SP being in the direction opposite from the immediately preceding change in the setting value SP for a change in the setting value SP wherein the setting value SP is changed, by the setting value operating portion, when the elapsed time after a change in the setting value SP is no more than a prescribed time.

7. The fault detecting system as set forth in claim 5, wherein:
the operation summation information is repeat change summation information indicating a summation of the magnitudes of changes of the setting value SP, repeat change summation information indicating a summation of the magnitudes with which the setting value SP is changed again, through the setting value operating portion, prior to the process variable PV, after the change, arriving at the setting value SP after the setting value SP has been changed, and/or opposite-direction change summation information indicating a summation of the magnitudes of changes of the setting value SP being in the direction opposite from the immediately preceding change in the setting value SP for a change in the setting value SP wherein the setting value SP is changed, by the setting value operating portion, prior to the process variable PV, after the change, arriving at the setting value SP after the setting value SP has been changed.

8. The fault detecting system as set forth in claim 5, further comprising:
an alarm outputting portion that outputs an alarm when a value of the operation summation information exceeds a threshold value prescribed in advance.

9. The fault detecting system as set forth in claim 1, further comprising:
a frequency information acquiring portion that acquires, at intervals prescribed in advance, operation frequency information held in the frequency information processing portion;
a reset value transmitting portion that transmits a reset signal to the resetting portion after the operation frequency information has been acquired;
a frequency information history storing portion that stores operation frequency information acquired by the frequency information acquiring portion; and
an evaluating portion that outputs an alarm when an amount of increase in a value of a most recent operation frequency information relative to a value of the operation frequency information hat an arbitrary point in the past, stored in the frequency information history storing portion, exceeds a threshold value prescribed in advance.

10. The fault detecting system as set forth in claim 5, further comprising:
a summation information acquiring portion that acquires, at intervals prescribed in advance, operation summation information held in the summation information processing portion;
a reset value transmitting portion that transmits a reset signal to the resetting portion after the operation summation information has been acquired;
a summation information history storing portion that stores operation summation information acquired by the summation information acquiring portion; and
an alarm outputting portion that outputs an alarm when an amount of increase in a value of a most recent operation summation information relative to a value of the operation summation information hat an arbitrary point in the past, stored in the summation information history storing portion, exceeds a threshold value prescribed in advance.

11. A fault detecting method comprising:
a manipulated variable calculating step for calculating and outputting a manipulated variable MV based on a setting value SP and a process variable PV;
a frequency information processing step for tabulating and holding, by a frequency information processing portion, operation frequency information for indicating a frequency of change of the setting value SP by an operation by an operator; and
a resetting step for resetting to zero the operation frequency information that is held in the frequency information processing portion when a reset signal is received from the outside.

12. The fault detecting method as set forth in claim 11, further comprising:
an alarm outputting step for outputting an alarm when a value of the operation frequency information exceeds a threshold value prescribed in advance.

13. A fault detecting method comprising:
a manipulated variable calculating step for calculating and outputting a manipulated variable MV based on a setting value SP and a process variable PV;
a summation information processing step for tabulating and holding, by a summation information processing portion, operation summation information for indicating a summation of change of the setting value SP by an operation by an operator; and
a resetting step for resetting to zero the operation summation information that is held in the summation information processing portion when a reset signal is received from the outside.

14. The fault detecting method as set forth in claim 13, further comprising:
an alarm outputting step for outputting an alarm when a value of the operation summation information exceeds a threshold value prescribed in advance.

15. The fault detecting method as set forth in claim 11, further comprising:
a frequency information acquiring step for acquiring, at intervals prescribed in advance, operation frequency information held in the frequency information processing portion;
a reset value transmitting step for transmitting a reset signal after the operation frequency information has been acquired;
a frequency information history storing step for storing, into a frequency information history storing portion, operation frequency information acquired by the frequency information acquiring step; and
an evaluating step for outputting an alarm when an amount of increase in a value of a most recent operation frequency information relative to a value of the operation frequency information hat an arbitrary point in the past, stored in the frequency information history storing portion, exceeds a threshold value prescribed in advance.

16. The fault detecting method as set forth in claim 13, further comprising:
a summation information acquiring step for acquiring, at intervals prescribed in advance, operation summation information held in the summation information processing portion;
a reset value transmitting step for transmitting a reset signal after the operation frequency information has been acquired;
a summation information history storing step for storing, into a summation information history storing portion, operation summation information acquired by the summation information acquiring step; and
an evaluating step for outputting an alarm when an amount of increase in a value of a most recent operation summation information relative to a value of the operation summation information hat an arbitrary point in the past, stored in the summation information history storing portion, exceeds a threshold value prescribed in advance.
